(19) United States
(12) Patent Application Publication
(10) Pub. No.: US 2010/0163483 A1
(43) Pub. Date: Jul. 1, 2010

(54) FOOD PROCESSING RESOURCE RECOVERY

(75) Inventors: Michael Grady, Wellesley, MA (US); Joe Phillips, Barhamsville, VA (US); William Baker, Moncure, NC (US); Sam Jaffe, Cookesville, TN (US); Kathy L. Jaffe, Cookeville, TN (US)

Correspondence Address: SEYFARTH SHAW LLP, WORLD TRADE CENTER EAST, TWO SEAPORT LANE, SUITE 300, BOSTON, MA, 02210-2028, US

(73) Assignee: ZENTOX CORPORATION, Wellesley Hills, MA (US)

(21) Appl. No.: 12/504,975

(22) Filed: Jul. 17, 2009

Related U.S. Application Data
(60) Provisional application No. 61/081,784, filed on Jul. 18, 2008.

(51) Int. Cl. C02F 3/00; C02F 1/24; C02F 103/32

(52) U.S. Cl. 210/608; 210/704

(57) ABSTRACT

A method of hydrolyzing peptide bonds in waste material from dissolved air flotation (DAF float) wastewater treatment systems is disclosed. The method according to the disclosure comprises controlling the pH of said DAF float; adding a lytic agent to said pH controlled DAF float; and incubating the lytic agent/DAF float mixture. The hydrolyzed peptide bonds allow for the cleaving of oil molecules from protein material thereby increasing oil extraction from wastewater streams.

### CROSS-REFERENCES TO RELATED APPLICATIONS

This application claims priority to U.S. Provisional Patent Application No. 61/081,784 filed on Jul. 18, 2008.

### FIELD OF INVENTION

The present disclosure relates to an apparatus and a method for resource recovery from food processing systems such as organic wastes containing biomass (biological resource), utilizing chemistries to cleave oil molecules from protein.

### BACKGROUND OF INVENTION

A common approach to wastewater pretreatment in the food processing industry is the utilization of dissolved air flotation systems (DAF). Typically in order to comply with Federal, State and local discharge requirements, prior to the discharge of wastewater streams to a Publicly Owned Treatment Works (POTW), DAFs are commonly used for the reduction of Biochemical Oxygen Demand (BOD), Total Suspended Solids (TSS) and Fats, Oil and Grease (FOG). Wastewater discharge requirements vary from location to location, however, they continue to become more restrictive and costly.

In the operation of a DAF air is injected into the wastewater flow to create bubbles which lift the insoluble wastewater contaminants in the form of a concentrated float, or sludge. This float is then skimmed from the surface of the wastewater (DAF Float). A DAF can typically reduce TSS and FOG by about 90 to 99% which is often sufficient to meet discharge requirements. In those wastewater streams in which the BOD is not solubalized into water, BOD can be reduced by up to about 75-85%. However, in wastewater streams containing high levels of soluble BOD, the reduction of this constituent may only be by about 10-40% which may be insufficient to meet wastewater discharge requirements.

The principle method by which a DAF is able to remove wastewater contaminants is through flotation. If contaminants are dissolved into water they cannot be effectively treated by DAF. Solubalized BOD is a serious problem faced by slaughter houses (Live Kill Plants) that kill and eviscerate large numbers of live animals daily (i.e., a typical poultry plant processes 250,000 birds per day) and generate large volumes of blood, some of which ends up in the wastewater stream. Blood is solubalized into water and becomes a major element of soluble BOD in the wastewater stream of a Live Kill Plant.

Achieving Federal, State or local BOD discharge limits can be a major cost and challenge for Live Kill Plants. Failure to meet increasing restrictive BOD discharge regulations may result in sizeable surcharges being assessed by the local POTW or in extreme cases result in closure of a Live Kill Plant.

In order to meet ever tightening discharge regulations, the wastewater treatment operation of a Live Kill Plant is typically augmented with chemicals that enable the DAF to more effectively reduce contaminants such as BOD. The most commonly used treatment aid for this purpose is ferric chloride, ferric sulfate or other metal salts, at times aided by the pre-addition of an acid (Metal Salts Chemistry). When mixed with wastewater, the Metal Salts Chemistry causes a chemical reaction with the solubalized BOD. The Metal Salts Chemistry sufficiently lowers the pH of the wastewater stream to a typical target range of about 4.3-5.8 pH which facilitates precipitation/coagulation of blood components in water. In some instances the pH for DAF Float produced with Metal Salts Chemistry is below about 4.3 pH. The result is that a significant portion of the BOD becomes insoluble and therefore is available to be captured in the DAF Float. In addition to being an effective wastewater treatment aid, Metal Salts Chemistry is significantly lower priced compared to other chemistries that might be able to achieve similar reductions in BOD.

While Metal Salts Chemistry is indeed effective at removing solubalized BOD from wastewater streams of Live Kill Plants, this chemistry tends to create other challenges that appear in the DAF Float itself. As an example, DAF Float produced with Metal Salts Chemistry tends to retain more moisture than DAF Float produced with other chemistries as water tends to stay bonded more tightly to the solids.

Unfortunately, the excessive moisture and increased weight makes DAF Float treated with Metal Salts Chemistry more expensive to transport and to further process (i.e., dewater) compared to DAF Float produced with alternative chemistries. Over the years, Live Kill Plants have attempted to dewater Metal Salts Chemistry DAF Float through the use of sludge presses. However, in most cases the use of sludge presses with this type of DAF Float has not been successful. It is difficult at best to dewater DAF Float produced with Metal Salts Chemistry.

The primary alternative to Metal Salts Chemistry is treatment of wastewater in a DAF with one or more polymers (Polymer Chemistry). Polymer Chemistry is generally 50 to 100% more expensive than Metal Salts Chemistry which may translate into $70,000 to $140,000 per year in increased chemical costs at a typical poultry processing plant. Despite this increased cost, however, the efficiency of Polymer Chemistry is not comparable to Metal Salts Chemistry at removing solubalized BOD from wastewater. In some instances, if BOD discharge limits are low (i.e., tight discharge limits), the inability to remove soluble BOD can result in significant surcharges. There are however some geographic locations where discharge requirements are such that they are achievable with Polymer Chemistry. One of the major benefits of Polymer Chemistry is that the DAF Float produced by this method is not as problematic as DAF Float produced by Metal Salts Chemistry in that it tends not to hold as much moisture and is therefore easier to dewater.

DAF Float is a reality of any Live Kill Plant that utilizes DAF technology. The issue of disposal of DAF Float is complicated in large part due to the sheer volume of DAF Float produced by a Live Kill Plant. While these plants vary in size and operation, it is not unusual for example for a typical U.S. poultry processing plant to produce in excess of 100,000 lbs. of DAF Float per day from a wastewater stream of approximately 1 million gallons. On average, the DAF Float from such an operation can hold approximately 80% moisture. Because of the large volume of water in the DAF Float and the increasingly stringent government regulations on its disposal, the costs associated with the handling of DAF Float can be very high.

A food processor typically has several options for disposal of DAF Float. In the meat and poultry industries, since the DAF Float contains protein, one option has been to send the DAF Float to a rendering plant. Due to problems in processing DAF Float, however, few renderers have been willing to accept such waste material. Since DAF Float may contain about 80% moisture, versus a much lower moisture level in the offal from the plant (which is the primary feed stock of a renderer), the evaporation cost for DAF Float is usually prohibitive. As noted above, in addition to a higher moisture content, DAF Float produced by Metal Salts Chemistry holds the moisture more tightly making dewatering much more difficult. In addition, many renderers feel that the combination of high moisture and residual water treatment chemicals such as Metal Salts Chemistry cause coating problems in the cookers which may inhibit heat transfer resulting in an increased cost of processing. The age of DAF Float is also a factor that creates both processing and cost problems for a renderer. After 24 hours of standing, raw DAF Float undergoes a dramatic increase in Free Fatty Acids (FFA) of the fat and overall rancidity of the DAF Float. The renderers who process DAF Float require that the sludge be less than 24 hours old and that food processors pay a dewatering charge for the DAF Float containing an excessive moisture level. Renderers will usually not accept DAF Float produced with Metal Salts Chemistry. These issues have forced many food processors to search for other disposal methods for DAF Float. In addition, renderers typically charge a fuel surcharge which further reduces any perceived value for the DAF float.

The most common method of disposing of DAF Float, other than rendering, is land application. Typically, for this method the processor pays two fees: 1) a fee to have the DAF float hauled to a location suitable for land application and 2) a fee to have the DAF Float land applied. Depending on the location of a food processing plant, the DAF Float can be transported many miles for land application. A typical poultry processing plant can produce more than 100,000 lbs of DAF Float per day or 25 million lbs per 250 day processing year. With the assumption of a combined cost of transportation and disposal of $25/ton, the annual cost per year to the food processor to dispose of DAF Float from a single plant can be in excess of $300,000. Costs will vary depending upon location of the plant relative to available sites for land application. In addition to ever increasing costs, industry experts predict that this disposal route will be eliminated altogether in the not distant future due to ever tightening environmental laws.

In the 1980's an alternative approach to the traditional treatment and disposal of DAF Float was proposed by centrifuge equipment vendors. This approach was, and still is, referred to as “resource recovery.” One of the early proponents of this approach was Bird Environmental Systems and Services, Inc. (see “Elimination of DAF Sludge Disposal Through Resource Recovery” Bird Environmental Systems and Services, Inc.). This approach combined heating DAF Float to 180-200 degrees F. and then processing it through a 3-phase centrifuge. The objective was to break down the DAF Float into its three principle components: water, solids and oil. The water could be sent to the wastewater treatment plant, the solids might have value to a renderer (although this is not likely if produced with Metal Salts Chemistry) and the oil would have commercial value. Bird Environmental estimated that with their prescribed mode of operation the DAF Float, on average, would be broken into the following constituents parts: 90% water, 7% solids and 3% oil.

Although Bird Environmental Systems and Services no longer appears to be in business at least two other major equipment vendors—Alfa Laval and Centrisys Centrifuge Systems—provide 3-phase centrifuges to the food processing industry. The mode of operation recommended by centrifuge equipment manufacturers today is the same as proposed by Bird Environmental 20 years ago—heat the DAF Float to about 180-200 degrees F. and then process the DAF Float with the 3-phase centrifuge. Unfortunately, not much has changed in this technology in 20 years. Today, centrifuge equipment manufacturers will typically report that they can achieve 3-4% oil extraction by volume in DAF Float produced by Metal Salts Chemistry and perhaps 5-6% in DAF Float produced by Polymer Chemistry.

Despite these oil recovery levels, very few plants have actually installed centrifuge equipment to process DAF Float. There are several examples where poultry plants have installed centrifuge systems but the equipment in most cases did not operate efficiently and the results were very disappointing. While there have been some successes, for the most part DAF Float dewatering with sludge presses has not been successful which is another indication of how tightly water is held in DAF Float especially when produced with Metal Salts Chemistry.

In general, over the past 20 years there does not appear to have been much adoption of the centrifuge resource recovery model by Live Kill Plants and in particular by poultry Live Kill Plants. The poultry industry in particular appears to be very skeptical that DAF Float is a viable resource recovery feed stock. Unfortunately, the industry has never seen commercially reasonable volumes of oil being extracted from DAF Float.

### SUMMARY OF THE INVENTION

According to the disclosure, a method of hydrolyzing peptide bonds in the waste material from dissolved air flotation (DAF float) wastewater treatment systems is disclosed. The method according to the disclosure comprises controlling or adjusting the pH of said DAF float; adding a lytic agent to said DAF float; and incubating the lytic agent/DAF float mixture.

It is a further object of the disclosure that pH adjustments are made first followed by an addition of a lytic agent including by not limited to a proteolytic enzyme.

It is an additional object of the disclosure that lytic enzymes are pH dependent and pH adjustment of a DAF float needs to reach an acceptable pH level before the enzyme is added.

In yet a further object of the disclosure that increased oil yields can be produced by using dramatic shifts in pH of the DAF float. This shifting of pH, to increase oil yields, includes but is not limited to shifting from acid float to basic float and then back to an acid float. The pH of the float in one illustrative embodiment was adjusted to a point where the solution was homogenous composition having a basic pH of about 12 and then adjusted to a pH of about 6.8. It is contemplated within the scope of the disclosure that the shifting of the pH from an acid pH to a basic pH and than back to an acid pH increased the enzymatic activity of selected enzymes.

It is a further object of the disclosure that the shifting of pH is accomplished by the addition of compounds including but not limited to sodium hydroxide to move the pH of the float to a basic pH and compounds including but not limited to sulfuric acid to move the pH of the float to an acidic pH. It is further contemplated within the scope of the disclosure that the shifting of the pH can be for a selected period of time needed to have a homogeneous pH within a float.

It is an object of the disclosure that lytic agents added to the float cleave oil molecules from protein matter thereby increasing the extraction of oil from wastewater streams.

It is a further object of the disclosure that lytic agents such as protease enzyme are used to cleave oil molecules from protein matter within waste water streams.

It is another further object of the disclosure that lytic inducing agents such as chemical agents to adjust pH are used either alone or in combination with protease enzyme to cleave oil molecules from protein matter within waste water streams.

It is yet a further object of the disclosure that lytic inducing agents such as proteolytic bacteria are used either alone or in combination with protease enzyme to cleave oil molecules from protein matter within waste water streams. It is contemplated within the scope of the disclosure that proteolytic bacteria can be used to cleave oil molecules from protein matter. These proteolytic bacteria include but are not limited to Butyrivibrio sp., Butyrivibrio sp., Eubacterium sp., or the like and mixtures thereof.

It is yet a further object of the disclosure that lytic agents such as protease enzyme are used to cleave oil molecules from protein matter within waste water streams and that pH adjustment increases yield of said cleaved oil molecules.

It is another further object of the disclosure that lytic agents such as protease enzyme are used to cleave oil molecules from protein matter within waste water streams and that temperature adjustment increases yield of said cleaved oil molecules.

It is another further object of the disclosure that chemical agents to adjust pH are used in combination with selected periods of heating said waste water stream to increase yield of said cleaved oil molecules.

It is yet a further object of the invention that the invention according to the methods disclosed herein can result in an extraction of about 90%+ of available oil from DAF Float samples.

It is another object of the invention to increase the extraction of about 6,000 lbs of oil per day (assuming 50% extraction of 12% available oil) from a DAF Float stream of 100,000 lbs using prior art methods to about 10,800+ lbs. of oil using the methods according to the disclosure.

It is a further object of the invention to extract meaningful volumes of oil from a DAF Float stream making the entire resource recovery process economically viable.

It is another object of the invention that the extracted oil is converted to biodiesel the daily extract of 10,800 lbs of oil would equal 1,480 gallons of fuel. Assuming net revenue of $3.30/gallon ($4.00 value less $0.70 consumables) the annual value of this oil stream is $1.2 million.

Finally, it is a further object of the disclosure of a more effective and economical means to break the fat-protein bond in DAF Float than the traditional temperature adjustment and centrifugal force method, there may be opportunities to produce oil recovery yields that exceed those realized to date. This may include use of other enzymes, chemicals or additives than those used to date as well as modifications to the wastewater treatment chemistry used to produce the DAF Float. Dosages and types of wastewater treatment chemistries may be optimized to enable a Live Kill Plant to both produce wastewater that meets discharge permits and at the same time maximizes the volume of oil that can be economically recovered from the DAF Float.

### BRIEF DESCRIPTION OF THE DRAWINGS

Advantages of the present invention will become apparent to those skilled in the art upon reading and understanding the following detailed description with reference to the accompanying figures.

FIG. 1 is a graphic depiction of the increase oil yield according to methods of the disclosure;

FIG. 2 is a graphic depiction of the increase oil yield according to the methods of the disclosure having the variables of heat and pH; and

FIG. 3 is a graphic depiction of the increase oil yield according to the methods of the disclosure having the variables of heat and pH.

### DETAILED DESCRIPTION OF THE DISCLOSURE

Detailed embodiments of the present disclosure are disclosed herein, however, it is to be understood that the disclosed embodiments are merely exemplary of the disclosure, which may be embodied in various forms. Therefore, specific functional details disclosed herein are not to be interpreted as limiting, but merely as a basis for the claims and as a representative basis for teaching one skilled in the art to variously employ the present disclosure in virtually any appropriately detailed embodiment.

The instant disclosure is directed to a method of extracting significantly greater amounts of oil from a DAF Float. Oil extraction from a Live Kill Plant according to the disclosure has economic value for a variety of uses including as an ingredient in animal feed as well as having potential as primary feed stock for biodiesel fuel.

In prior art methods, the industry expectation (both centrifuge equipment vendors and Live Kill Plant operators) has been that of the volume of DAF Float produced by a Live Kill Plant (i.e., 100,000 lbs. per day) only about 3-4% is extractable oil if the DAF Float is produced by Metal Salts Chemistry and perhaps about 5-6% if produced by Polymer Chemistry.

An analysis of samples of DAF Float (analytical method: AOAC 922.06, 948.15) has determined that the actual amount of oil present in DAF Float from several Live Kill Plants (assuming an average moisture level of 80%) averaged approximately about 12%+. This amount of oil represents about 2-3 times the average amount normally extracted under current prior art methods. This amount of oil is far beyond the expectation of industry professionals. Prior art methods have suggested that there was only 3% oil available from DAF float.

Without being bound to any particular theory it is thought that a significant portion of the oil present in DAF Float is encapsulated, bound or tied together with protein. It is further thought that the oil which is bound to protein is not released by centrifugal force at temperatures of 180-200 degrees F. The oil remains encapsulated or bound to the protein and is believed to be primarily locked into the solids produced by the 3-phase centrifuge. If produced with Polymer Chemistry, the presence of oil in the solids may enable these solids to have value if sold to a renderer. On the other hand, if produced with Metal Salts Chemistry it would be unlikely that a renderer will accept the solids. Even in the best case scenario of solids produced with Polymer Chemistry and paid for by a renderer the oil would have significantly greater value if extracted rather than left in the solids as demonstrated below:

There are several methods to break the fat-protein bond. One technique is to use high (250-300 degrees F.) amounts of heat which is the approach utilized in the rendering industry. Unfortunately, because of high energy cost this prior method is no longer feasible. The method according to the disclosure, having significant costs advantages, is to break the fat-protein bond via an enzymatic reaction. According to the disclosure, the breaking of this fat-protein bond can happen in DAF Float or other biologic waste medium, produced by chemistries including Metal Salts Chemistry or Polymer Chemistry. It is within the scope of this disclosure that low cost Metal Salts Chemistry, which is effective at BOD removal, can now also produce DAF Float that can be efficiently harvested for significant greater amounts of oil. This is a significant cost benefit for a food processor struggling to meet a tight BOD discharge level.

Enzymatic Reaction to Break Fat-protein bond—According to the disclosure an effective way to break the fat-protein bond is via an enzymatic reaction. By adding a proteolytic enzyme to the DAF Float protein is broken down and oil is released. This hydrolyzing effect can be visually observed as the enzyme is added and mixed into the DAF Float—oil literally begins to float to the surface. In one illustrative embodiment a protease enzyme, Alkaline Protease L from Bio-Cat, Inc., was used within a DAF float to extract significant amounts of oil. It is contemplated within the scope of the disclosure that between about 1.23 and 2.46 kg of Alkaline Protease L per 8,000 lbs of solids (on average) are utilized in a DAF Float stream of 100,000 lbs. (assuming moisture content of 80%).

It is contemplated within the scope of the disclosure that other proteolytic enzymes or the like and mixtures thereof could also achieve acceptable results. According to the disclosure enzymes including but not limited to achromopeptidase, aminopeptidase, ancrod, angiotensin converting enzyme, bromelain, calpain I, calpain II, carboxypeptidase A, carboxypeptidase B, carboxypeptidase G, carboxypeptidase P, carboxypeptidase W, carboxypeptidase Y, caspase 1, caspase 2, caspase 3, caspase 4, caspase 5, caspase 6, caspase 7, caspase 8, caspase 9, caspase 10, caspase 11, caspase 12, caspase 13, cathepsin B, cathepsin C, cathepsin D, cathepsin E, cathepsin G, cathepsin H, cathepsin L, chymopapain, chymase, chymotrypsin, clostripain, collagenase, complement C1r, complement C1s, complement factor D, complement factor I, cucumisin, dipeptidyl peptidase IV, elastase, endoproteinase Arg-C, endoproteinase Asp-N, endoproteinase Glu-C, endoproteinase Lys-C, enterokinase, factor Xa, ficin, furin, genenase I, granzyme A, granzyme B, HIV protease, IGase, kallikrein tissue, leucine aminopeptidase, matrix metalloprotease, methionine aminopeptidase, neutrase, papain, pepsin, plasmin, prolidase, pronase E, prostate specific antigen, alkalophilic protease, protease S, proteasomes, proteinase from A. oryzae, proteinase 3, proteinase A, proteinase K, protein C, pyroglutamate aminopeptidase, renin, rennin, streptokinase, subtilisin, thermitase, thermolysin, thrombin, tissue plasminogen activator, trypsin, tryptase, urokinase, mixtures thereof or the like.

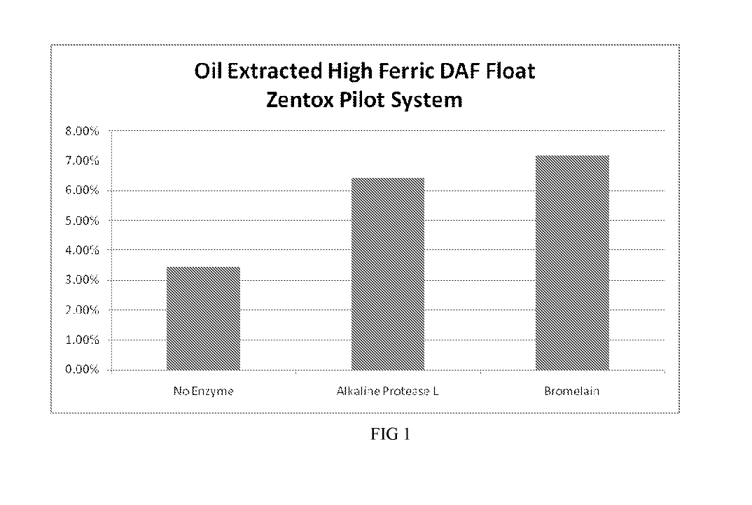

According to the disclosure the DAF Float may require different types of lytic agents or mixtures thereof to achieve maximum results. In a further illustrative embodiment, in a DAF Float produced with high levels of Metal Salts Chemistry, the Alkaline Protease L enzyme tended to lose some of its effectiveness at higher doses. Without being bound to any particular theory, it is thought that the loss of effectiveness may be the result of the ferric in the Metal Salts Chemistry interfering with the enzymatic activity. In those DAF floats having high levels of Metal Salts Chemistry, a change to the Bromelain proteolytic enzyme from Bio-Cat, Inc. in samples of high ferric DAF Float has demonstrated a meaningful improvement in oil yield over that achieved in identical samples with the Alkaline Protease L enzyme as shown in FIG. 1.

As depicted in FIG. 1, an identical DAF Float sample was produced with high levels of ferric Metal Salts Chemistry. According to the disclosure, it is thought that the higher the amount of Metal Salts Chemistry used to produce a particular DAF Float stream the greater the challenge to break the fat-protein bond.

Maximizing Enzyme Reaction with pH Adjustments and Heating Time: It is thought that DAF Float from a chemistry that results in a very low pH such as about 2.8 is more difficult to treat than DAF Float with a higher pH. According to the disclosure DAF Float with such a low pH may require different types of lytic agents or mixtures of other agents and conditions to achieve maximum results.

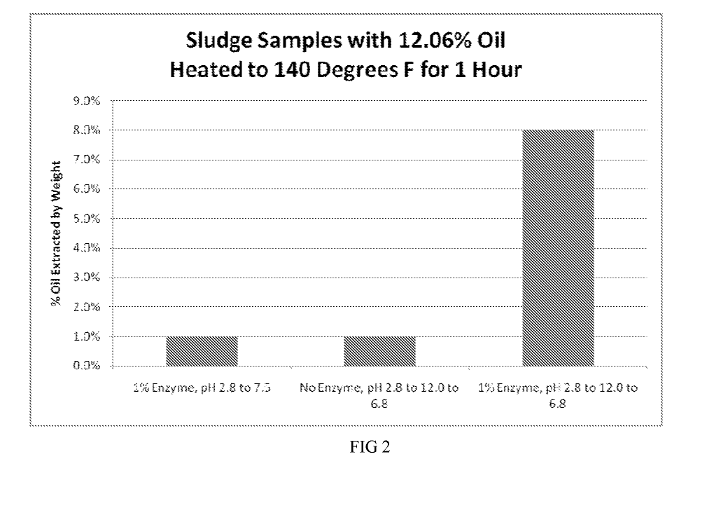

In a further illustrative embodiment, a DAF Float produced with an unknown chemistry had a pH of about 2.8. In this particular float, the use of an enzyme alone was not effective in releasing significant volumes of oil. It is believed that the chemistry used to produce this DAF Float was being used in an effort to meet a particularly tight discharge permit. In these samples significant volumes of oil were released through a combination of making multiple dramatic changes to the pH through the addition of sodium hydroxide (to increase pH) and sulfuric acid (to reduce pH) in combination with enzymes as shown in FIG. 2.

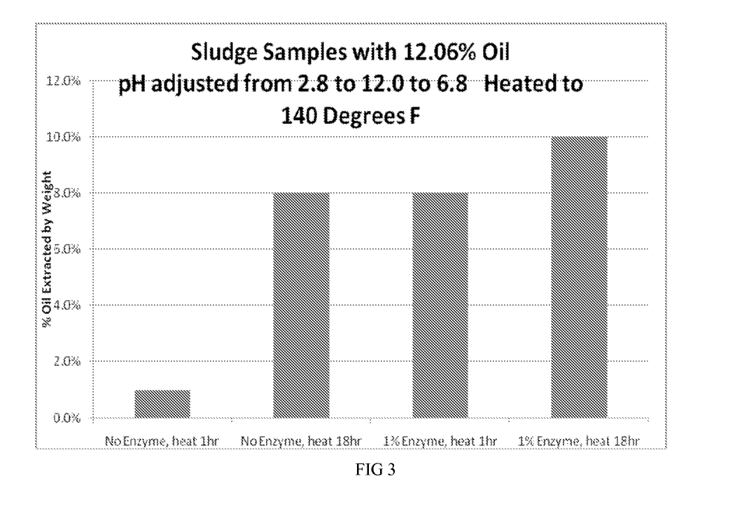

In an another illustrative embodiment, in the samples from the same DAF Float with a pH of about 2.8 significant volumes of oil were released through either the addition of enzyme or use of extended heating periods both in combination with making dramatic changes to the pH through the addition of sodium hydroxide (to increase pH) and sulfuric acid (to reduce pH) in combination with enzymes as shown in FIG. 3.

As depicted in FIGS. 2 and 3, several identical DAF Float samples were produced with a pH of 2.8. According to the disclosure, it is thought that the higher the amount of chemistry used to produce a particular DAF Float stream with an extremely low pH the greater the challenge to break the fat-protein bond.

Maximizing Enzyme Reaction with pH Control: It is thought that different enzymes are either more or less effective at different pH levels. The pH of the DAF Float will therefore determine the amount of enzyme necessary to achieve satisfactory results. The process may be maximized in terms of oil extraction rates by controlling pH within specific ranges, although the incremental gains realized by controlling pH may not justify the incremental costs. In one illustrative embodiment it was found that a significant incremental gain in oil extraction happens when the pH is not adjusted as the samples depicted in FIG. 1 demonstrate. These samples shown in FIG. 1 had no pH adjustment. Without being bound to any particular theory it is thought that the control of pH may play a more significant role in oil extraction from DAF Float produced by Metal Salts Chemistry than from Polymer Chemistry.

Heating of the DAF Float: Heating the DAF Float to about 180-200 degrees F. as prescribed by current day centrifuge manufacturers does not appear to benefit the breaking of the fat-protein bond and may actually be detrimental. It appears that when heat increases to about 160-170 degrees F. the fat-protein bond may actually increase due to protein contraction (i.e., when meat is cooked it shrinks) resulting in a tighter bond and one less amenable to be broken via a centrifugal force. At extreme heat (250-300 degrees F.) it is commonly believed that all of the oil would be cooked out of the protein which is the mode of operation in a rendering plant. However, 180-200 degrees F. has proven not to be sufficient to break the fat-protein bond and this level of increased temperature may actually tighten the fat-protein bond.

According to the disclosure a temperature sufficient enough to facilitate efficient and thorough mixing of the DAF Float, enzyme and other added agents is preferable. In one illustrative embodiment it was found that a minimum temperature of approximately 100 degrees F. was preferred with an upper level of approximately 140 degrees F. Advantageously, one of the benefits of the method according to the disclosure is that it allows a reduction in resource recovery operating costs by reducing operating temperature.

### EXAMPLES

The following examples are illustrative of the present disclosure and are not to be considered as limiting the methods according to the disclosure.

### Example I

There are large amounts of oil in DAF Float from Live Kill Plants that is currently not being extracted. The key to harvesting this oil is to cost effectively break the fat-protein bond according to the disclosure that exists in the DAF Float and thereby making the oil available to be extracted. The cost benefits are as follows in a single plant:

| | |
|---|---|
| DAF Float/day = | 100,000 lbs. |
| Moisture | 80% |
| Oil | 12% |
| Solids | 8% |
| 8,000 lbs of dry solids (add back moisture to make 50% | $480/day |
| water) equals 16,000 lbs. Assume a value of $.03/lb = | for solids |
| Normal oil extraction rate under current | 6,000 lbs |
| procedures @ 50% = | |
| New extraction rate under new | 10,800 lbs |
| disclosure procedures @ 90% = | |
| Incremental oil extracted = | 4,800 lbs |
| Incremental oil value @ $0.35/lb = | $1,680/day |
| Incremental benefit (($1,680 vs. $480) × 250 days) = | $300,000/year |

### Example II

Assume the following for a single plant:

| DAF Float/day = | 100,000 lbs. |
|---|---|
| Available oil = | 12% |
| Oil extraction rate = | 90% |
| Recovered oil per day = | 10,800 lbs. per day |
| Oil value if sold at $0.35/lb = | $3,780/day |
| Oil value per year = | $945,000 |

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method of hydrolyzing peptide bonds in the float from dissolved air flotation (DAF float) wastewater treatment systems, comprising:
adding a lytic agent to said DAF float; and
incubating the lytic agent/DAF float mixture.

2. The method of claim 1, further comprising the step of controlling the pH of said DAF float, said pH of said DAF float is between about 2 to about 12.

3. The method of claim 1, wherein the lytic agent is an enzyme.

4. The method of claim 3, wherein the enzyme is a proteolytic enzyme.

5. The method of claim 4, wherein the proteolytic enzyme is selected from the group consisting of alkaline protease, achromopeptidase, aminopeptidase, ancrod, angiotensin converting enzyme, bromelain, calpain I, calpain II, carboxypeptidase A, carboxypeptidase B, carboxypeptidase G, carboxypeptidase P, carboxypeptidase W, carboxypeptidase Y, caspase 1, caspase 2, caspase 3, caspase 4, caspase 5, caspase 6, caspase 7, caspase 8, caspase 9, caspase 10, caspase 11, caspase 12, caspase 13, cathepsin B, cathepsin C, cathepsin D, cathepsin E, cathepsin G, cathepsin H, cathepsin L, chymopapain, chymase, chymotrypsin, clostripain, collagenase, complement C1r, complement C1s, complement factor D, complement factor I, cucumisin, dipeptidyl peptidase IV, elastase, endoproteinase Arg-C, endoproteinase Asp-N, endoproteinase Glu-C, endoproteinase Lys-C, enterokinase, factor Xa, ficin, furin, genenase I, granzyme A, granzyme B, HIV protease, IGase, kallikrein tissue, leucine aminopeptidase, matrix metalloprotease, methionine aminopeptidase, neutrase, papain, pepsin, plasmin, prolidase, pronase E, prostate specific antigen, alkalophilic protease, protease S, proteasomes, proteinase from A. oryzae, proteinase 3, proteinase A, proteinase K, protein C, pyroglutamate aminopeptidase, renin, rennin, streptokinase, subtilisin, thermitase, thermolysin, thrombin, tissue plasminogen activator, trypsin, tryptase, urokinase, and mixtures thereof.

6. The method of claim 1, wherein the lytic agent is selected from the group consisting of a chemical, enzyme and bacteria.

7. The method of claim 1, wherein said lytic agent/DAF float mixture is incubated for between about 1 hour and about 1 day.

8. A method of extracting oil in wastewater streams in food processing plants, comprising:
creating a DAF float;
controlling the pH of said DAF float;
adding a lytic agent to said pH controlled DAF float; and
incubating the lytic agent/DAF float mixture.

9. The method of claim 8, wherein said controlled pH of said DAF float is between about 2 to about 12.

10. The method of claim 9, wherein said controlled pH of said DAF float is adjusted to a pH of about 12 for a selected period of time and then adjusted to a pH of about 6.8.

11. The method of claim 10, wherein the enzyme is a proteolytic enzyme.

12. The method of claim 11, wherein the proteolytic enzyme is selected from the group consisting of alkaline protease, achromopeptidase, aminopeptidase, ancrod, angiotensin converting enzyme, bromelain, calpain I, calpain II, carboxypeptidase A, carboxypeptidase B, carboxypeptidase G, carboxypeptidase P, carboxypeptidase W, carboxypeptidase Y, caspase 1, caspase 2, caspase 3, caspase 4, caspase 5, caspase 6, caspase 7, caspase 8, caspase 9, caspase 10, caspase 11, caspase 12, caspase 13, cathepsin B, cathepsin C, cathepsin D, cathepsin E, cathepsin G, cathepsin H, cathepsin L, chymopapain, chymase, chymotrypsin, clostripain, collagenase, complement C1r, complement C1s, complement factor D, complement factor I, cucumisin, dipeptidyl peptidase IV, elastase, endoproteinase Arg-C, endoproteinase Asp-N, endoproteinase Glu-C, endoproteinase Lys-C, enterokinase, factor Xa, ficin, furin, genenase I, granzyme A, granzyme B, HIV protease, IGase, kallikrein tissue, leucine aminopeptidase, matrix metalloprotease, methionine aminopeptidase, neutrase, papain, pepsin, plasmin, prolidase, pronase E, prostate specific antigen, alkalophilic protease, protease S, proteasomes, proteinase from A. oryzae, proteinase 3, proteinase A, proteinase K, protein C, pyroglutamate aminopeptidase, renin, rennin, streptokinase, subtilisin, thermitase, thermolysin, thrombin, tissue plasminogen activator, trypsin, tryptase, urokinase, and mixtures thereof

13. The method of claim 8, wherein the lytic agent is selected from the group consisting of chemical, enzyme and bacteria.

14. The method of claim 8, wherein said lytic agent/DAF float mixture is incubated for between about 1 hour and about 1 day.

15. A method of treating wastewater from food processing plants, comprising:
creating biological waste material;
controlling the pH of said waste;
adding a lytic agent to said pH controlled waste; and
incubating the lytic agent/waste mixture.

16. A method of extracting oil from biological waste containing oil and protein, comprising:
controlling the pH of said waste; and
adding a lytic agent to said pH controlled waste.

17. The method according to claim 16, further comprising incubating said lytic agent with said pH controlled waste to hydrolyze chemical bonds between said oil and said protein within said pH controlled waste.

18. The method according to claim 16, wherein said pH is between about 2 and about 12.

19. The method according to claim 16, wherein said lytic agent is selected from the group consisting of chemicals, bacteria and enzymes.

20. The method according to claim 16, wherein said incubation occurs for between about 1 hour and about 1 day.
